(19) United States
(12) Patent Application Publication
(10) Pub. No.: US 2024/0042916 A1
(43) Pub. Date: Feb. 8, 2024

(54) Flexible Bunk Room for Recreational Vehicles

(71) Applicant: Heartland Recreational Vehicles, LLC, Elkhart, IN (US)

(72) Inventor: Eric M. Bailey, Niles, MI (US)

(21) Appl. No.: 17/803,524

(22) Filed: Aug. 8, 2022

(51) Int. Cl. B60P 3/39

(52) U.S. Cl. CPC B60P 3/39

(57) ABSTRACT

An RV is provided having a multi-use bunk bed room which re-purposes lateral bed platform panels into table/desk, workbench, sleeping bed, or vertical storage modes, and establishes a multi-use interior door, movable between room closure, storable item shield, and “cushion closet” modes, with strategic alignment between an exterior baggage door and the interior room door to accommodate oversized storable items.

### BACKGROUND OF THE INVENTION

The present invention relates generally to motorized and towable recreational vehicles (“RVs”), such as travel trailers, toy haulers, fifth wheel trailers, motor homes, and the like, having at least living quarters therein, and as otherwise defined by the Recreational Vehicle Industry Association, more information about which can be found on the Internet at www.rvia.org. More particularly, the present invention relates to RVs which have a floor plan including a bunk bed or bunk room arrangement.

RVs are typically versatile vehicles which may be used for concurrently or separately hauling equipment, other vehicles, personal property, people, and animals. RVs are often used for camping and/or recreation, or as temporary living quarters for an extended period of time. Usually, an RV is constructed with an interior with living quarters having a variety of features therein, such as beds, kitchens, bathrooms, furniture, cabinets, tables. and counter tops. Storage areas are commonly formed within the living quarters which can be accessed from interior of the RV and/or from the exterior of the RV. As such, the removable contents or “storable items” of an RV can include camping equipment, other vehicles (such as golf carts, ATVs, race cars, dune buggies) and tools therefor, chairs, tables, tents, bar-b-ques, small boats, swimming toys and accessories, ski and snowboard gear, etc.

In general, it is desirable to design RVs for maximum flexibility, in terms of the uses to which it can be put. At the same time, RVs are typically limited in size and weight, both as a matter of purchaser economics, drivability or towability limitations, fuel economy, and because of various governmental usage regulations. Thus, there is not an unlimited possibility for increased living area and/or storage space when designing an RV floor plan and constructing the RV. Accordingly, RV construction should usually be as efficient as possible, so as to maximize both the volume and type of usable living area floor space and/or storage space within the vehicle, and the ease of using those spaces.

Previously, it has been suggested that the interior of an RV can be constructed to accommodate a greater number of users or provide more features for the same number of users by employing vertically stacked sleeping beds or “bunk beds,” rather than use the same number separately spaced beds in the horizontal plane. However, separately spaced beds in the horizontal plane often each have storage bins or the like formed under each of them to accommodate, for example, the personal effects of that bed's users. Stacking the sleeping beds into a bunk bed arrangement may still allow sufficient usable space for the storage bins under the lower bunk bed, but the upper bunk bed would typically be without its own storage area.

Furthermore, RVs are not always used with the same number of people or the people using the RV do not at all times need to use it for sleeping. Accordingly, having extra structure, and associated weight and cost, for any extra beds, including bunk beds, is not always needed. Previously, it has been suggested that single beds or vertically stacked bunk bed structures can be made more versatile by forming each sleeping bed from a platform which is hinged to an interior wall of the RV. Such platforms can be pivoted up or down to a vertical position and locked against the wall when the bed is not needed, and thereby open up usable floor space for some other purpose (such as storage of users' personal items, cargo, etc. When the extra bed is needed, then the platform is unlocked, and then pivoted downward (or upward) to a horizontal position to support a mattress and form the bed. However, such platforms are often heavy to lift, can be awkward to lock in place securely, are relatively expensive (at least due to the hinge structure needed, as well as the possible interior wall reinforcement structure, and/or folding legs used for temporary support), and require extra temporary storage accommodation for the unused mattress. Also, inadvertent release of the locking mechanism can cause significant property damage and personal injury, especially when the platform is pivoted upwardly for storage.

It has been suggested that such bed platforms can use a hinge intermediate their widths and running along the longitudinal length of the platform, making them easier to lift out of the way. However, unless a second hinge is used along the portion of the platform adjacent the interior wall of the bed room, the floor space made available by such a “half bed hinge” would only be half as much. Using the second hinge can allow the full floor space under the bed to be available for alternative use, but it adds that much more cost and weight to the RV, and can be even heavier to lift into place when forming the bed.

It has been suggested that bed platforms can be fitted into place on interior ledges or wall projections of the RV and simply removed, along with the mattresses or cushions used on them to form the bed, when not needed. However, given the length of typical beds, these platforms and cushions would not be readily accommodated for even temporary storage in many places within the RV. Further, the length and weight of such platforms can make them awkward to lift and move, especially without risk of damage to other RV interior furnishings and surfaces.

Other RV floor plan design difficulties can arise when trying to maximize the type and size of items which are storable within the RV. For example, in addition to dedicated storage bins, closets, drawers, and the like, the interior space of the RV which encompasses the living area of the RV when the vehicle is not in motion, can be used to temporarily store items when the vehicle is in motion. However, it can be more difficult to store longer items within an RV, such as paddle boards, kayaks, wood poles or beams since that item would have to be navigated into the RV through doors sized for people and typically smaller storable items, and placed around and/or adjacent the fixed interior contents. Moreover, once within the RV, the inherent RV motion and shifting forces imposed on RV contents by vehicular travel can create damage both to the storable items and to the interior RV feature surfaces (scratching or denting walls, snagging furniture fabric, etc.). It has been suggested that some of these difficulties can be alleviate by the use of enlarged baggage doors opening from the exterior of the RV to its interior, but then the aperture of such openings typically faces pre-existing interior structures and furnishings or precludes the use of such items at the aperture location.

In addition, RV users may desire to have office and/or work space within the vehicle. A permanent, dedicated office or workspace reduces the portion of the living area of the vehicle which can be enjoyed when the office and/or workspace is not needed. A temporary, removable office and/or workspace takes up additional storage area and adds significant weight and cost when it is not being used.

Also, improvements in RV design and manufacturing, as well as changes in the features employed within the RV living space, occur frequently. However, many prior RV floor plans are optimized for the particular time that RV was manufactured, but are not readily retrofittable to take full advantage of desirable features and advantages which have been developed since that time. Accordingly, users are occasionally required to choose between forgoing currently available features and advantages or purchasing an entirely new RV.

All at the same time, the aesthetics of an RV are important to its design. The overall appearance of the RV interior, both in terms of its furnishings and its floor plan layout, can determine much of its desirability to end users.

### OBJECTIVES OF THE INVENTION

Accordingly, a primary objective of the invention is to provide improved floor plans for vehicles having living quarters therein. These improvements include providing such arrangements which:
a. are inexpensive to manufacture, install, maintain, and repair,
b. increase floor plan optimization when used in a vehicle, such as an RV,
c. minimize component weight,
d. increase storage area and accessibility thereto,
e. increase supplemental feature accessibility and user comfort,
f. are readily retro-fitted into pre-existing RVs, and
f. increase the aesthetic appeal of RVs.

### SUMMARY OF THE INVENTION

These and other objectives of the present invention are achieved by the provision of an RV having a multi-use bunk bed room which flexi-purposes lateral bed platform panels into table/desk, workbench, sleeping bed, or vertical storage modes, and establishes a multi-use interior door, movable between room closure, storable item shield, and “cushion closet” modes, with strategic alignment between an exterior baggage door and the interior room door to accommodate oversized storable items.

Other objects, advantages, and novel features of the present invention will become readily apparent from the following drawings and detailed description of certain preferred and alternative embodiments.

### CHARACTERIZATION OF THE DESIGN AESTHETICS OF THE INVENTION

The present invention comprises, for example, the aesthetic appearance of an RV interior and an RV floor plan having a narrow, bunk room, cleanly convertible into a wide space storage room with the bunk components compactly arranged along the walls when not in use, as well as the appearance of in-line closeable interior and exterior openings from that room.

### BRIEF DESCRIPTION OF THE DRAWINGS

FIG. 1 shows a top plan view of a RV incorporating a best mode embodiment of the present invention, as a floor plan drawing, with the slide-out portion extended from the vehicle.

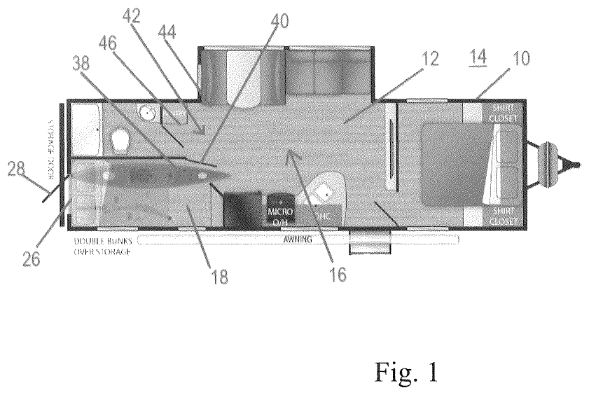

FIG. 2 shows a top schematic view of the embodiment of FIG. 1 with specific features and furnishings of the RV (including beds 60 and 66) omitted for ease of view and with the door 40 in the open position to accommodate long storage item 38.

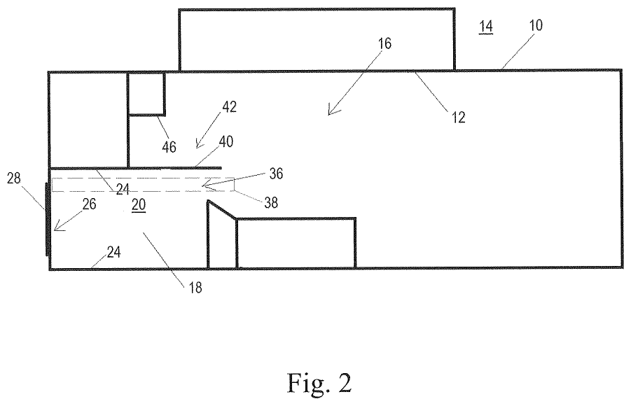

FIG. 3 shows a top schematic view, corresponding with the view of FIG. 2, except that door 40 is closed to isolate room 18.

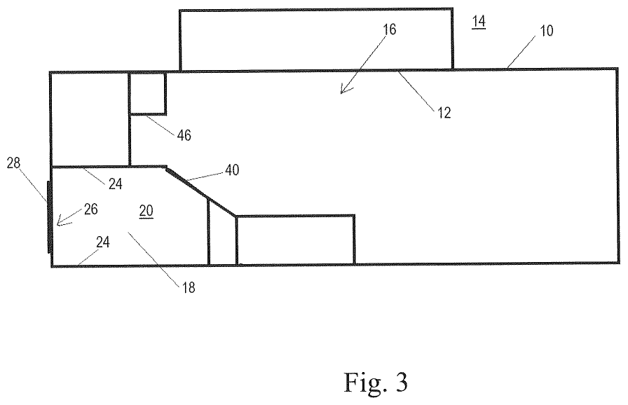

FIG. 4 shows a top schematic view, corresponding with the view of FIG. 2, except that door 40 is closed to isolate enclosure 48.

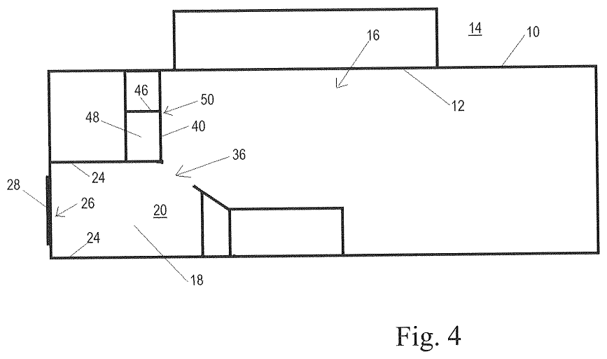

FIG. 5 shows a top schematic view, corresponding with the view of FIG. 2, and indicating dimensional references of room 18.

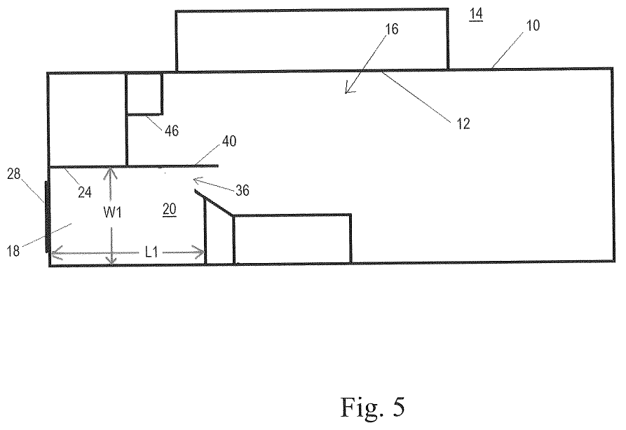

FIG. 6 shows a top schematic view, corresponding with the view of FIG. 2, and indicating cross-sectional reference lines for room 18.

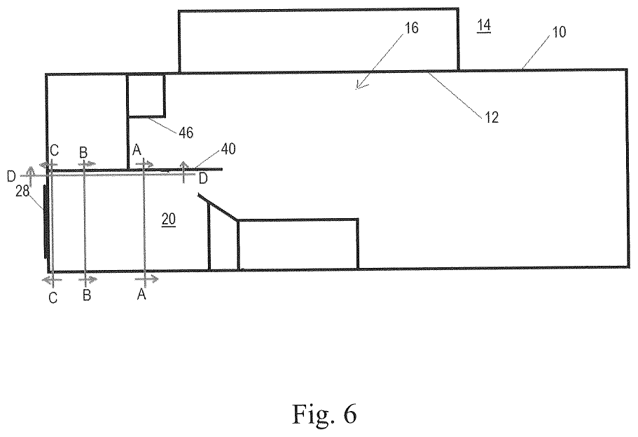

FIG. 7 shows a cross sectional schematic view along lines AA of FIG. 6 and in the direction of the arrows, with beds 60 and 66 in place within room 18, but with the cushions removed.

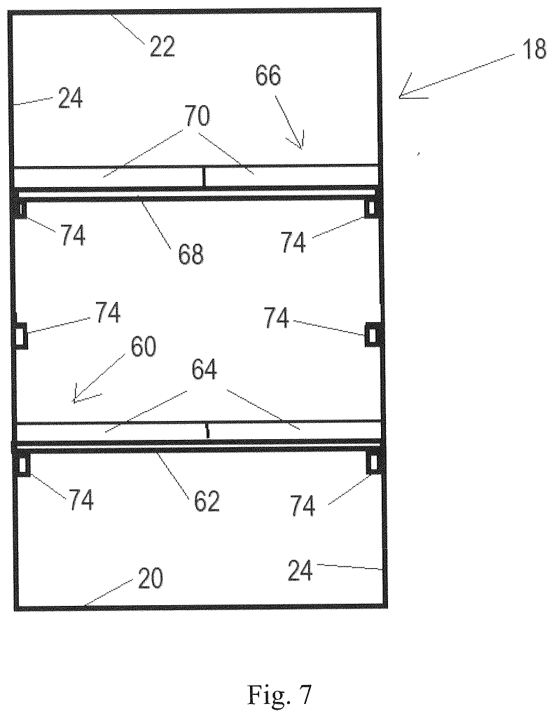

FIG. 8 shows a cross sectional schematic view corresponding with the view of FIG. 7 indicating dimensional references of the beds.

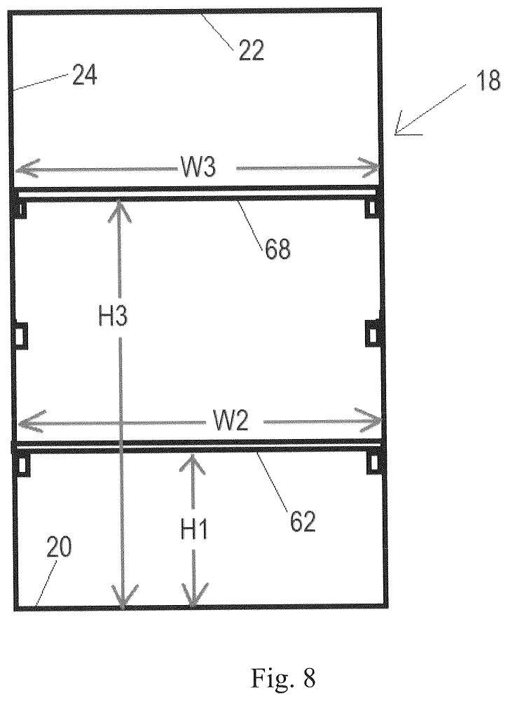

FIG. 9 shows a cross sectional schematic view along lines BB of FIG. 6 and in the direction of the arrows, with bed 66 in place and its cushions removed, and with bed 60 removed and its panels 62 vertically stacked for storage against wall 24.

FIG. 10 shows a cross sectional schematic view along lines BB of FIG. 6 and in the direction of the arrows, with beds 60 and 66 removed and a panel 62 or 68 placed as a desktop, workstation or shelf at height H2.

FIG. 11 shows a cross sectional schematic view along lines BB of FIG. 6 and in the direction of the arrows, with beds 60 and 66 removed and their panels vertically stacked for storage along walls 24.

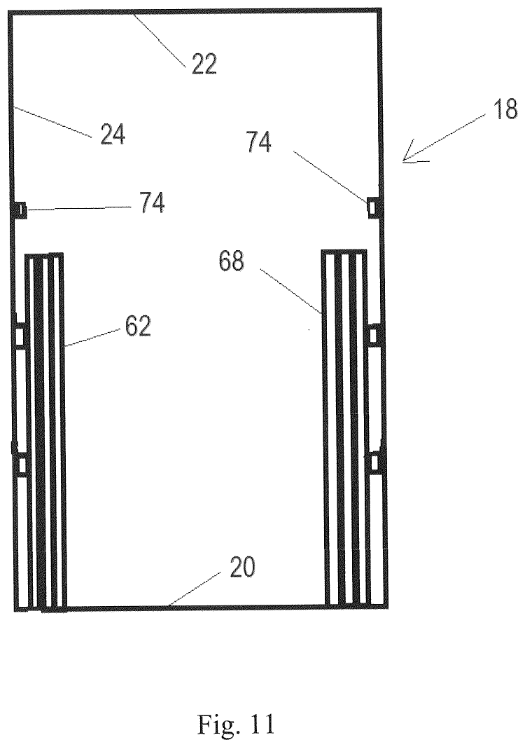

FIG. 12 shows a cross sectional schematic view along lines CC of FIG. 6 and in the direction of the arrows, with beds 60 and 66 removed.

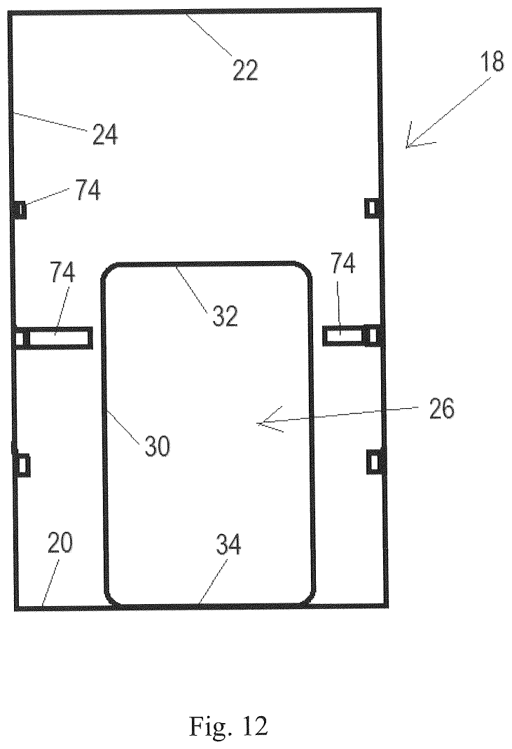

FIG. 13 shows a cross sectional schematic view along lines DD of FIG. 6 and in the direction of the arrows, with beds 60 and 66 removed.

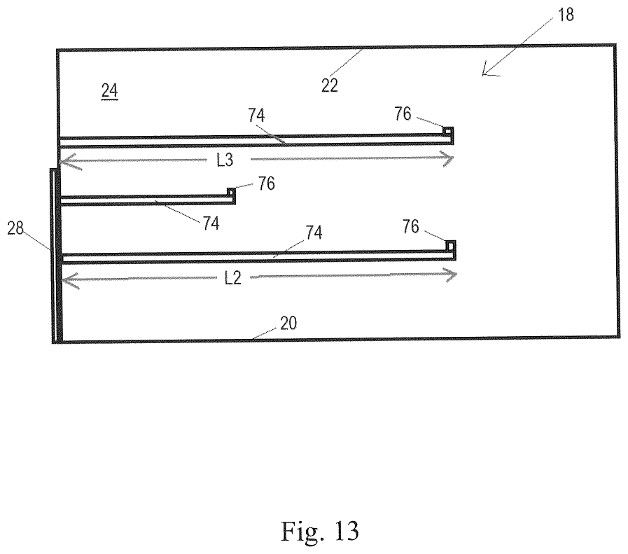

FIG. 14 shows a top view of bed 60, with longitudinally extending cushions 64 in place.

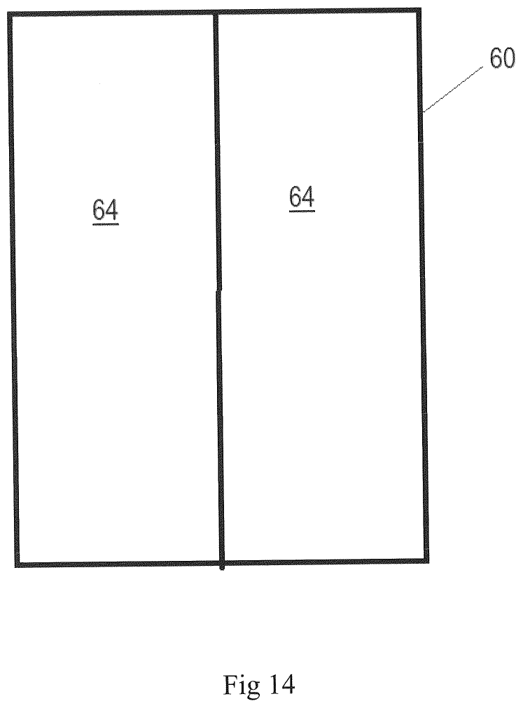

FIG. 15 shows a top view of bed 60 with cushions 64 removed, revealing laterally extending panels 62.

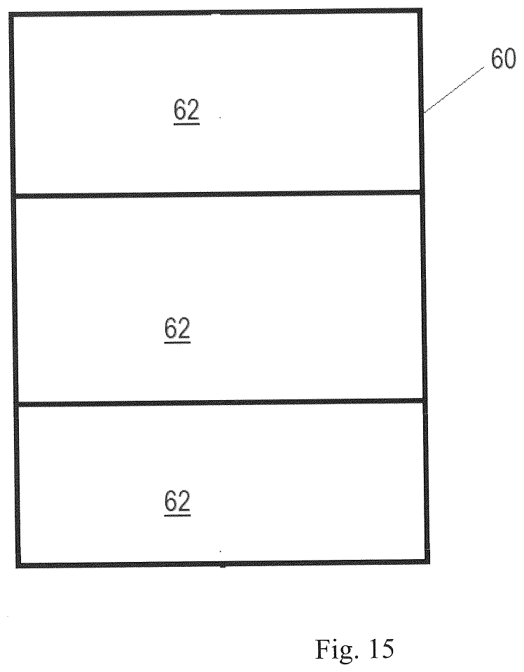

FIG. 16 shows a photographic view of a best mode embodiment of the present invention through opening 26 toward opening 36 with beds 60 and 66 removed, and a panel 62 placed as a desktop, workstation or shelf.

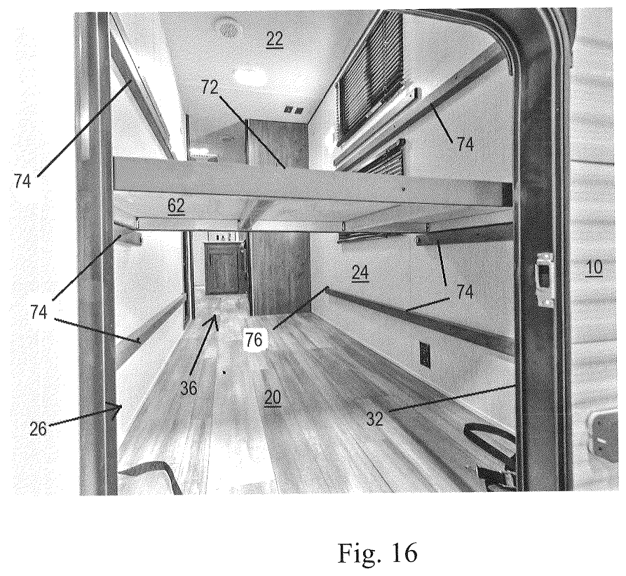

FIG. 17 shows a photographic view of a best mode embodiment of the present invention through opening 26 toward opening 36 with bed 60 in place, and bed 66 removed.

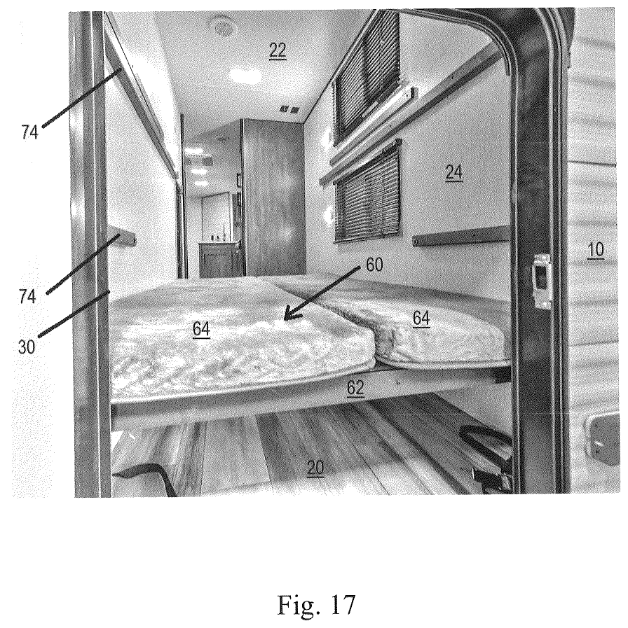

FIG. 18 shows a photographic view of a best mode embodiment of the present invention through opening 26 toward opening 36 with bed 66 in place and bed 60 removed and its panels 62 vertically stacked against wall 24 for storage.

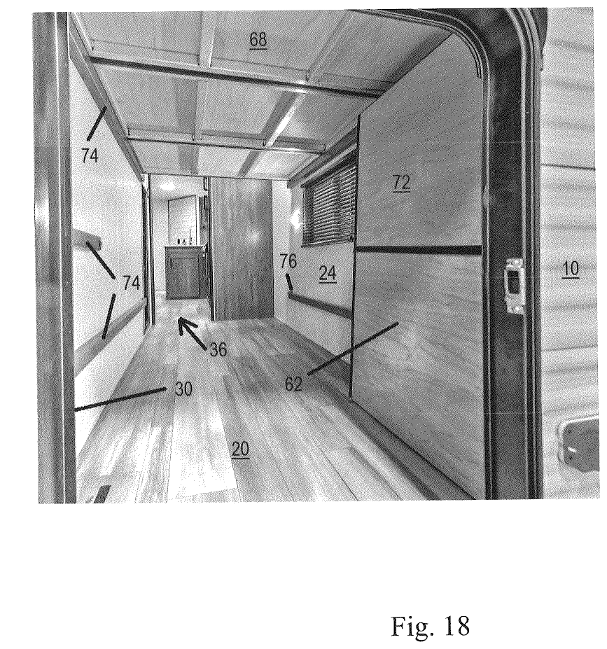

FIG. 19 shows a photographic view of a best mode embodiment of the present invention through opening 36 toward opening 26 with bed 60 removed and door 40 open to room 18 and not adjacent to other wall 46.

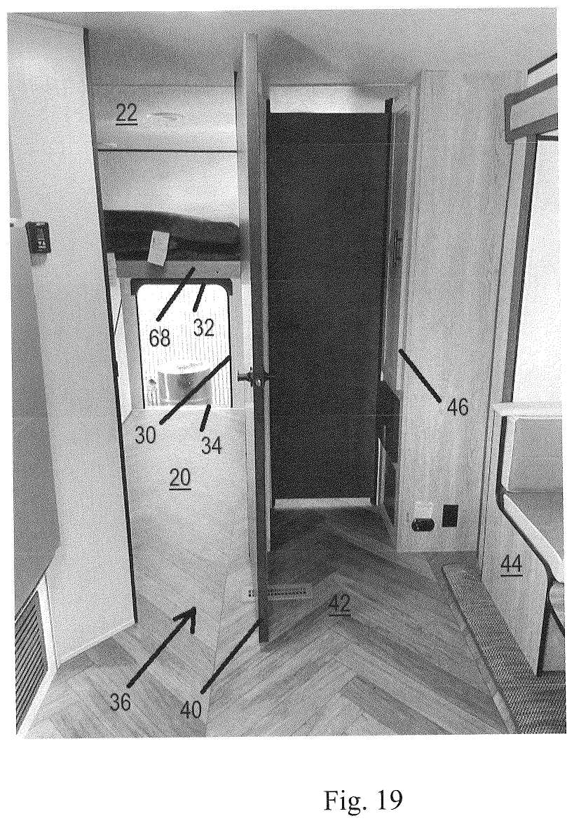

FIG. 20 shows a photographic view of a best mode embodiment of the present invention through opening 36 toward opening 26 with bed 60 removed and door 40 open to room 18 and adjacent to other wall 46 and to create enclosure 48.

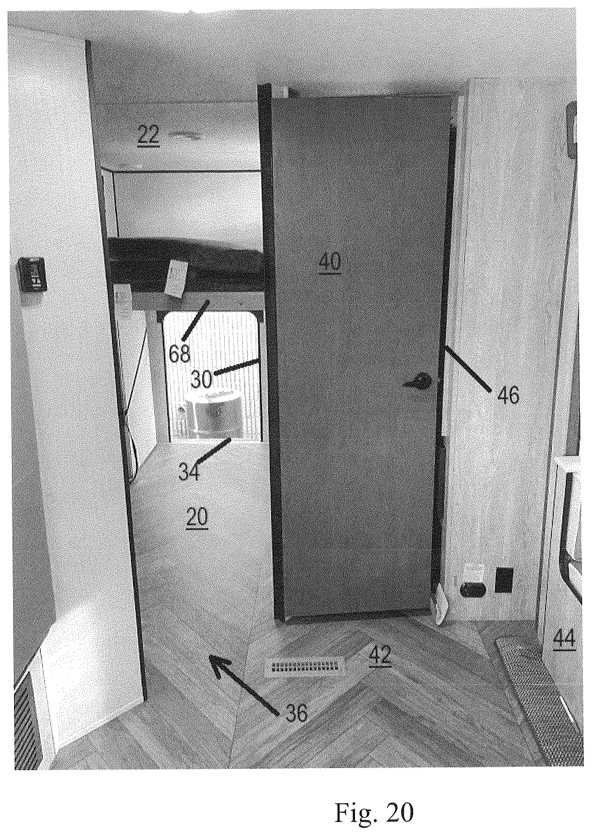

### DETAILED DESCRIPTION OF PREFERRED EMBODIMENTS

The figures show schematically, and in a best mode versions, embodiments of the present invention, as applied to a travel trailer type of RV, both generically and specifically. The drawings are not to scale from one view to the next.

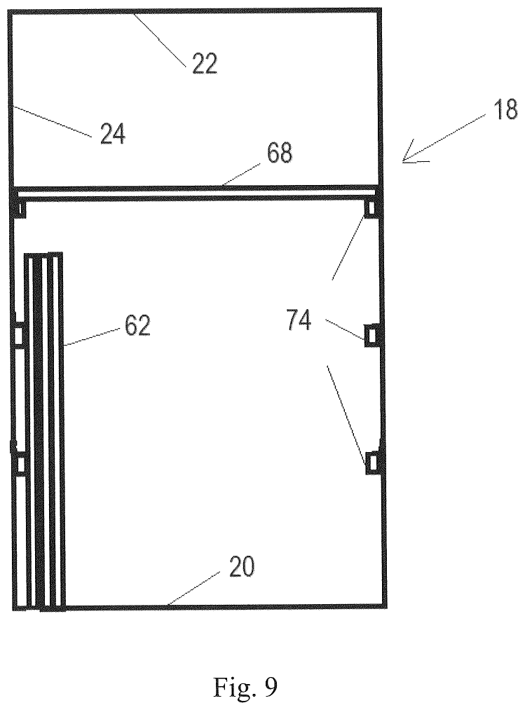

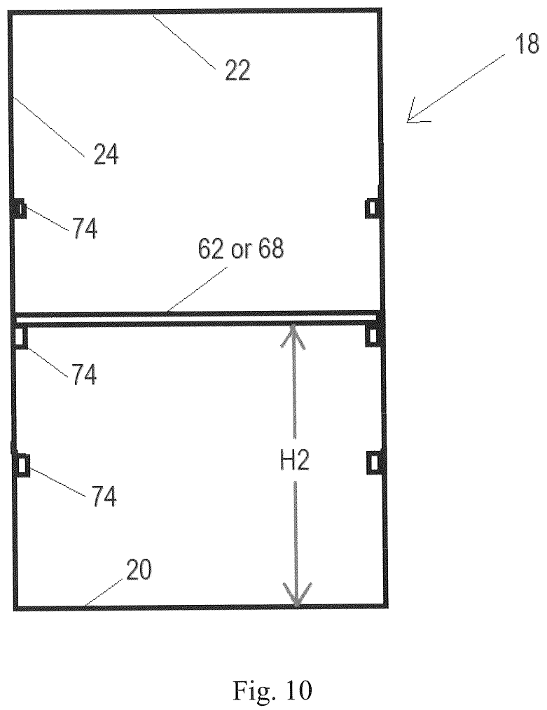

The following features are illustrated in the drawings by these numerals:
A vehicle 10 having
   an interior 12,
   an exterior 14,
living quarters 16 located within interior 12,
a bunk room 18 within living quarters 16 and partitioned from other portions of interior 12,
   the bunk room having:
      a length L1, a width W1, a floor 20, a ceiling 22, and walls 24 between the floor and ceiling,
      a first closable opening 26 between exterior 14 and room 18, formed with a perimeter 30 which has upper most portion 32 and lower most portion 34,
      a baggage door 28 connected to the vehicle for closing opening 26,
      a second closable opening 36, between room 18 and other portions of interior 12, and wherein the first and second closable openings are aligned such that a storable item 38, having a length greater than the length of room 18, can be inserted linearly through the first closable opening and the second closable opening,
      a door 40 which is pivotally mounted to selectively close the second closable opening, and movable into other portions 42 of the interior, and formed so as to prevent, at least in part, contact between storable items extending out of room 18 into the other portion of interior 12 with surfaces 44 of other portions of the interior,
an other wall 46 separate from any portion of room 18,
   door 40 is pivotable away from the second closable opening and into a position wherein a portion of door 40 is adjacent to other wall 46, and whereby an enclosure 48 is created outside of room 18, defined in part by door 40 and other wall 46,
   latching means 50 is connected to door 40 to releasably secure the door adjacent to other wall 46,
a first bed 60 for sleeping within room 18, having a width W2 and a length L2, and having
   a three removable underlying panels 62,
      each of those panels 62 extending across the width of the first bed, and
      those panels in combination (laid end to end) defining the length of the first bed
   two removable cushions 64 located on the underlying panels 62, each of those cushions extending across the length of the first bed
a second bed 66 for sleeping within room 18, disposed vertically above the first bed, having a width W3 and a length L3, and having
   three removable underlying panels 68,
      each of those panels extending across the width of the second bed, and
      those panels in combination (laid end to end) defining the length of the second bed, and
   two removable cushions 70 located on underlying panels 68, each of those cushions extending across the length of the second bed
the first bed is locatable adjacent to the first closable opening and is extendable across that opening at a first height H1 above the floor of the room which is intermediate the upper and lower most perimeter portions of that opening,
when not used as part of bed 60 or 66, at least one of the underlying panels 62 or 68 is removably mountable at a second height H2 above the floor, as shown in FIG. 10, and that panel or panels is formed with a planar surface 72 sufficient to serve as a tabletop or desk.
removable panels 62 are formed so as to be storable in a stacked orientation with respect to each other, and adjacent to a wall of the room, and beneath the second bed, as shown in FIG. 9 when the first plurality of removable panels is not used to form the first bed or another structure
at least one of either panels 62 or 68 is removably mountable at a third height H3 above the second height, independent of the other such panels
linear styles 74 mounted along the walls of room 18 to provide support for the panels at the first, second and third heights, and
   the styles include stops 76 to prevent unintended sliding of the panels along the styles.

In the illustrated embodiments, interior 12 includes both “living quarters” (meaning bedroom(s), bathroom(s), kitchen, living room and/or salon areas, etc. where vehicle users can sleep, refresh, eat and/or socialize) and dedicated storage areas into which vehicle users do not normally enter except to access items therein or clean, maintain, and/or repair (such as closets, conduits, appliances, baggage compartments, etc). The present invention is applied to create a flexible use area in what would normally be a dedicated bunk room of the living area. The present invention permits that bunk room to be used for sleeping, working, storage, and the like without extensive or laborious permanent or temporary structural modification.

In preferred embodiments, W1=W2=W3=H3 so as to optimize both utilization of the panels and their storage during non-use. Also, enclosure 48 is preferably formed such that cushions 64 and 70 can be stored standing on end therein and retained in place by door 40.

Styles 74 can be formed, for example, from square wood slats or metal flanges of L or C cross section. Styles for beds 60 and 66 can extend linearly for the entire length of the panels at the first and second heights, or intermittently along L2 and L3 as needed for sufficient support. Styles for the desk, work station, and/or storage shelf at the second height can also be mounted on the end wall of room 18 flanking opening 26 to provide additional support. Similarly, styles for a work station and/or storage shelf at the third height can also be mounted on the end wall of room 18 completely across that wall and above opening 26, as needed or preferred in a given application of the present invention.

In preferred embodiments, panels 62 or 68 are preferably supported by mounting on styles of at least two walls of room 18, such as when those panels are used to form the underlying support for beds 60 and 66. However, in applications where a panel 62 or 68 is mounted on a style of only one wall of room 18, such as for use as a table, bench, shelf, workstation, couch or the like, the panel can be formed with a fold down leg or strut or a support cable to provide additional stability.

Although denoted in the figures as only a rectangular phantom, longitudinally extending storable item 38 need not be only rectangular in shape. Instead, that item can be a kayak, paddle board, surf board, tent pole, fishing pole, or many other long objects which can be fit through both openings 26 and 36.

Door 40 is preferably mounted in its vertical position via a conventional piano hinge type of connection. Also, door 40 is preferably formed with a conventional knob and latch mechanism (not shown) for secure closure of opening 36. In certain embodiments that same knob and latch mechanism can also be used as latching means 50. However, it can be more aesthetically desirable to use a conventional strap with terminal snaps to secure door 40 in a releasably secure position adjacent other wall 46, when door 40 functions as a temporary closet (such as for cushions 64 and/or 70). Such strap/snap connections can be located at the lower or upper portions of door 40 and can releasably connected door 40 to other wall 46 or to other fixed surfaces adjacent thereto. Alternatively, latching means 50 can use conventional hooks and eye connections, slot/pin structures, magnets and the like.

Stops 76 can be formed or mounted on styles 74 and wood stopper blocks, pins, barrel locks or the like, as is conventionally used to stop linear sliding along a rail. Also, conventional straps or cords (not shown) can be used to facilitate retention of the panels in vertical storage positions against the wall(s) of room 18 (as they are shown to be in Fig. X).

Door 40 is preferably formed from materials which resist scratching or deformation from intermittent contact with storable item 38 or other features of interior 12, as that item and/or door 40 may be moved, vibrated, jostled or the like when being loaded into room 18 and/or when the vehicle is in motion. In additional, a conventional kickplate or reinforcing member can be mounted, for example, on the lower portion of door 40 or further resist damage thereto.

“Surfaces 44” refers to any furnishing or interior surface of the RV which is within the pivot path of door 40. In the drawings, surface 44 indicia is placed on a portion of the slide-out furniture, but as shown when the slide-out is extended from the interior, such as when the RV is not in motion. In motion, the slide-out is retracted in the conventional manner, and surfaces of the slide-out furniture will typically be substantially closer to door even able to be contacted by door 40. In that manner, door 40 can act as a shield against contact between surface 44 and storable item 38 when the vehicle is in motion.

While the present invention has been shown and described herein with respect to certain preferred embodiments and alternative configurations, that were by way of illustration and example only. For example, instead of three panels per bed, four or more panels can be used per bed, panels can be of different lengths (although the width of the panels would remain the same, preferably coinciding with the width of room 18). Also, the present invention can be readily applied to motor homes, boats, aircraft and other such vehicles. Accordingly, the spirit and scope of the present invention is intended to be limited only by the terms of the appended claims.

What is claimed is:

1. A vehicle having living quarters, including:
a first bed for sleeping, having a width and a length, and having
a first plurality of removable underlying panels,
each of those panels extending across the width of the first bed, and
the first plurality of those panels in combination defining the length of the first bed.

2. The vehicle according to claim 1 wherein the first bed further includes a first plurality of removable cushions located on the first underlying panels, each of those cushions extending the length of the first bed.

3. The vehicle according to claim 1, also including a second bed for sleeping, disposed vertically above the first bed, the second bed itself having a width and a length, and having
a second plurality of removable underlying panels,
each of those panels extending across the width of the second bed, and
the second plurality of those panels in combination defining the length of the second bed, and
the second bed further includes a second plurality of removable cushions located on the second underlying panels, each of those cushions extending across the length of the second bed.

4. The vehicle according to claim 1, also including:
an interior,
wherein the living quarters is located in the interior,
a room within the living quarters and partitioned from other portions of the interior,
the room having a length, a width, a floor, and a ceiling,
the room having a first closable opening, between the exterior of the vehicle and the room,
the first bed being located within the room, and
the width of the first bed corresponds with the width of the room.

5. The vehicle according to claim 4, wherein:
the first closable opening is formed with a perimeter which has upper most and lower most portions, and
the first bed is locatable adjacent to the first closable opening and is extendable across the opening at a first height above the floor of the room which is intermediate the upper and lower most perimeter portions of the opening.

6. The vehicle according to claim 5, wherein at least one of the underlying panels is removably mountable at a second height above the floor.

7. The vehicle according to claim 6 wherein the at least one underlying panel is formed with a planar surface sufficient to serve as a tabletop or desk.

8. The vehicle according to claim 5, wherein:
the room includes a second bed for sleeping, disposed vertically above the first bed, the second bed itself having a width and a length, and having a second plurality of removable underlying panels,
each of those panels extending across the width of the second bed, and
the second plurality of those panels in combination defining the length of the second bed.

9. The vehicle according to claim 8, wherein the first plurality of removable panels is formed so as to be storable in a stacked orientation with respect to each other, and adjacent to a wall of the room, and beneath the second bed, when the first plurality of removable panels is not used to form the first bed or another structure.

10. The vehicle according to claim 8, wherein at least one of either the first or second plurality of underlying panels is removably mountable at a second height above the floor, independent of the other such panels.

11. The vehicle according to claim 10 wherein at least one of either the first or the second plurality of underlying panels is removably mountable at a third height above the second height, in dependent of the other such panels.

12. The vehicle according to claim 11, wherein the room includes:
walls between the floor and ceiling, and
linear styles mounted along its walls to provide support for the panels at the first, second and third heights, and
the styles include stops to prevent unintended sliding of the panels along the styles.

13. The vehicle according to claim 4, also including:
a second closable opening, between the room and other portions of the interior, and
wherein the first and second closable openings are aligned such that a storable item having a length greater than the length of the room can be inserted linearly through the first closable opening and the second closable opening.

14. The vehicle according to claim 13, also including a door which is:
pivotally mounted to selectively close the second closable opening, and
movable into the other portions of the interior, and
formed so as to prevent, at least in part, contact between storable items extending out of the room into the other portion of the interior with surfaces of other portions of the interior.

15. The vehicle according to claim 14, wherein:
the interior includes an other wall separate from any portion of the room,
the door is pivotable away from the second closable opening and into a position wherein a portion of the door is adjacent to the other wall, and whereby an enclosure is created outside of the room, defined in part by the door and the other wall. and
latching means is connected to the door to releasably secure the door adjacent to the other wall.
